(19) United States
(12) Patent Application Publication
(10) Pub. No.: US 2008/0052166 A1
(43) Pub. Date: Feb. 28, 2008

(54) System and method for placement of local advertisements in national publications

(76) Inventors: James L. Warmus, La Grange, IL (US); Francis R. Costello, Westport, CT (US)

Correspondence Address: MCCRACKEN & FRANK LLP, 311 S. WACKER DRIVE, SUITE 2500, CHICAGO, IL, 60606, US

(21) Appl. No.: 11/894,413

(22) Filed: Aug. 21, 2007

Related U.S. Application Data
(60) Provisional application No. 60/839,548, filed on Aug. 22, 2006.

(51) Int. Cl. G06Q 30/00

(52) U.S. Cl. 705/14

(57) ABSTRACT

Advertisement information and subscriber profiles received from a publisher together with subscriber characteristics received from an advertising buyer are analyzed to provide a publication subscriber recommendation for the advertising buyer. The subscriber recommendation facilitates targeted advertising to selected publication subscribers.

### CROSS REFERENCE TO RELATED APPLICATIONS

The present application claims priority to U.S. Provisional Application No. 60/839,548, filed Aug. 22, 2006, which is incorporated herein by reference.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of Invention

The present invention relates generally to advertisement publishing systems and more particularly systems that enable sale of advertisements and targeted placement thereof.

2. Description of the Background of the Invention

National publications, such as magazines, include advertisements that target consumers within a geographic region (e.g., west coast, Manhattan, etc.) or in accordance with a broad demographic profile (e.g., pig farmers, dairy farmers, etc.). Local retailers typically have limited access to advertisement space in national publications in part because of the cost of advertising space on a national or regional basis. In addition, advertisement space in a magazine is sold to a single advertiser (e.g., for example, an advertisement that appears on a particular page of a regional version of a magazine contains the same advertisement). Although advertising in magazines may be customized on a national or regional basis, magazines are addressed to individual subscriber households and thereby distributed on an individual basis. The model used to sell advertising space in magazines (and other regional publications) does not lend itself to targeting advertisements to individual subscribers.

In contrast, a telephone directory (e.g., Yellow Pages®) contains advertisements for retailers in a neighborhood or a region and each resident in the neighborhood receives an identical directory. Similarly, local retailers place advertisements in inserts that are included in local newspapers or mass mailed publications (e.g., coupon books, mailers), identical copies of which are distributed to residents in the neighborhood. The distribution model used by directories, inserts, and mass mailed publications does not allow the local retailer to select the specific consumer or household that is to receive a particular advertisement.

Catalogs are similar to magazines in that advertising space therein is only available to the publisher of the catalog or to a group of advertisers who publish the catalog. Local retailers generally do not have access to advertising space in a catalog unless the retailer is a member of the group that publishes the catalog.

Video based publications such as television programs are also similar to magazines in that advertising space (i.e., commercial time) therein is only available on a regional basis and is not customized to an individual viewer of the publication.

### SUMMARY OF THE INVENTION

According to one aspect of the present invention, a method is provided that selects publication subscribers for targeted advertisements. This method includes receiving advertisement information and subscriber profiles from a publisher. In addition, subscriber characteristics are received from an advertising buyer. The advertisement information, subscriber profiles, and subscriber characteristics are analyzed and a publication subscriber recommendation is generated. A purchasing bid is received from the advertising buyer based on the publication subscriber recommendation.

A further aspect of the present invention is to provide a method for targeting advertising to selected publication subscribers. This method includes populating a database with advertisement information and subscriber profiles received from a publisher and subscriber characteristics received from an advertising buyer. A publication subscriber recommendation is generated from the database. This method further includes identifying an advertisement purchased by the advertising buyer, generating a final advertising file and a production database, and producing a customized advertisement from the final advertising file and the production database.

In another aspect of the present invention, a method is provided that selects publication subscribers for targeted advertisements. This method includes populating a database with advertisement information and subscriber profiles received from a publisher and subscriber characteristics received from an advertising buyer. The database is augmented with information provided by third party providers. A publication subscriber recommendation is generated and a purchasing bid is received from the advertising buyer based on the publication subscriber recommendation.

In still another aspect of the present invention, a system is provided for selecting a publication subscriber for a targeted advertisement. The system includes a database that comprises advertisement information and subscriber profiles received from a publisher, an interface that receives subscriber characteristics from an advertising buyer, and an analysis component. The analysis component analyzes the advertisement information, subscriber profiles, and subscriber characteristics in order to provide the advertising buyer with a publication subscriber recommendation. The system further includes an interface that receives a purchasing bid from the advertising buyer based on the publication subscriber recommendation.

Other features and advantages are inherent in the methods and system claimed and disclosed or will become apparent to those skilled in the art from the following detailed description in conjunction with the accompanying drawings.

### BRIEF DESCRIPTION OF THE DRAWINGS

FIG. 1 shows a functional diagram of an advertising publishing system;

FIG. 2 shows a flowchart of how mailing list data are used to populate a database of an embodiment the advertising publishing system shown in FIG. 1;

FIG. 3 shows a flowchart of how advertising available for sale by a publisher is added to the database of an embodiment of an advertising publishing system shown in FIG. 1;

FIG. 4 shows a flowchart of how an advertising buyer may purchase advertising space using of an embodiment of the advertising publishing system shown in FIG. 1;

FIG. 5 shows a flowchart of the preparation of advertising files for sending to a production facility by an embodiment of the advertising publishing system shown in FIG. 1;

FIG. 6 shows a flowchart for preparing a production database by an embodiment of the advertising publishing system shown in FIG. 1 that may be used by the production facility; and

FIG. 7 shows a flowchart for preparing a customized advertisement by an embodiment of the advertising publishing system shown in FIG. 1.

### DETAILED DESCRIPTION OF THE PREFERRED EMBODIMENTS

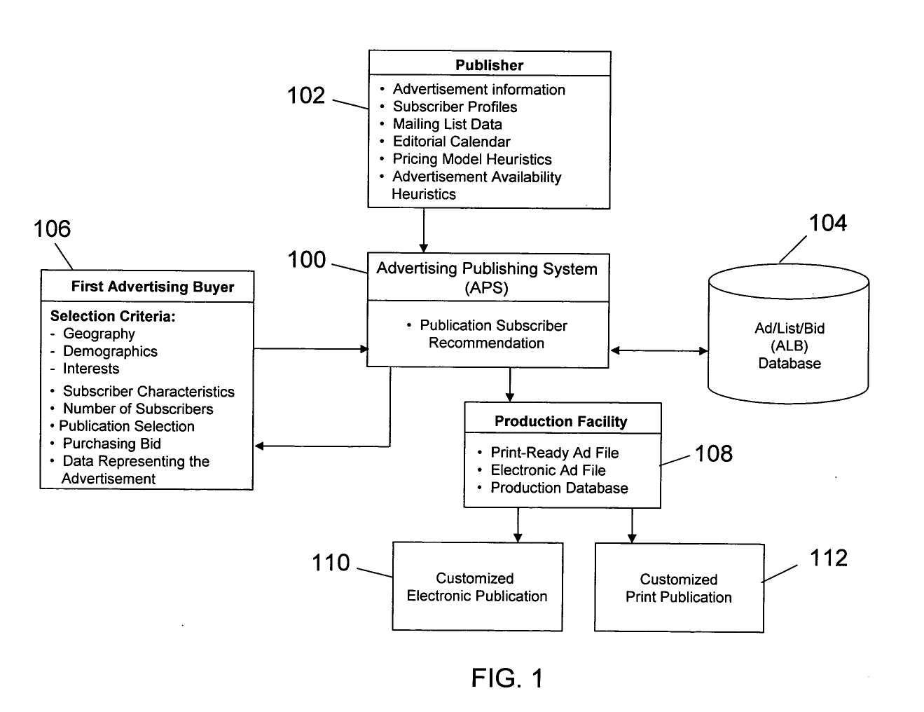

FIG. 1 shows a functional diagram of an advertising publishing system (APS) 100. A publisher 102 determines which publications published thereby are to include local advertisements provided through the APS 100. The publisher 102 may select all issues of one or more publications (e.g., all issues of a boating magazine, television programs in a season, etc.) or particular issues of a publication (e.g., only those issues that have excess advertising space or seasonal issues). For each publication selected by the publisher 102, the publisher 102 provides to the APS 100 advertisement information and subscriber profiles. In one embodiment, for each issue of a publication selected by the publisher 102, the publisher 102 provides an editorial calendar and information regarding advertising space available for sale through the APS 100. If the publication is delivered as video, then the advertising space refers to time allocated for advertising. The editorial calendar for an issue indicates the last date when advertising may be sold for the issue, the date by which final advertising content must be provided, or the date when the issue is expected to reach a subscriber's home.

The subscriber profiles include identification information for a subscriber and titles that the subscriber receives. The subscriber profile comprises demographic and interest information about the subscriber, such as geography, interests, income level, household type, and family profile. Some publishers provide subscriber profiles that comprise a name and an address of the subscriber. Other publishers, in order to protect subscriber privacy, for example, provide subscriber profiles that comprise a subscriber code. Additional subscriber profile information is necessary to determine the name and address of a subscriber from the subscriber code. In one embodiment, the additional subscriber profile information may be provided separately to systems that assemble and apply address information to publications.

A publisher 102 may update the advertisement information or the subscriber profiles previously provided to the APS 100. Specifically, the publisher 102 may provide additional names of new subscribers, delete names of subscribers who have terminated their subscriptions, edit identification information, or edit subscriber profiles. In some embodiments, the publisher 102 may provide updated data to the APS 100 that includes the advertisement information and subscriber profiles for all subscribers of a title. In other embodiments, the publisher 102 may provide updated data only for those subscribers whose advertisement information or profiles are to be modified. Additionally, the subscriber profiles can be cross-referenced between multiple participating publishers to ensure accuracy. All of the information provided by the publisher 102 is stored in an advertising/list/bid (ALB) database 104 of the APS 100. The ALB database 104 can be augmented with subscriber information provided by third parties to enhance targeting.

An advertising buyer 106 who wishes to purchase advertising real estate in a publication enters subscriber characteristics into the APS 100. The subscriber characteristics include a description of a target consumer and a period of time when the advertisement needs to reach the consumer. Advertising preferences that include, for example, information regarding a mailing region in which the advertising buyer would like an advertisement to appear and size of the advertisement can also be provided by the advertising buyer.

The APS 100 analyzes the subscriber characteristics provided by the advertising buyer and the advertisement information and subscriber profiles provided by one or more publishers stored in the ALB database 104 to identify and present to the advertising buyer 106 publication subscriber recommendations that include a count or quantity of subscribers. In one embodiment, the publication subscriber recommendations include candidate issues of titles that have advertising space available and, for each publication identified, circulation information and information regarding a collection of subscribers of the publication whose profiles match the demographic profile selected by the advertising buyer 106. In other embodiments, the publication subscriber recommendations include candidate programs of advertisements, either as a series of advertisements over time in a single title or over a series of titles. In yet other embodiments, information such as size of advertising space and costs of purchasing different sized advertisements is included in the publication subscriber recommendations.

Based on the publication subscriber recommendations, the advertising buyer 106 selects the number of subscribers who should receive an advertisement or one or more publications in which to place an advertisement. The advertising buyer 106 may also select a program of advertisements, either as a series of advertisements over time in a single title with customization to specified subscribers or over a series of titles sent to specified subscribers. In one embodiment, the space for the advertisement is sold at auction and an advertising buyer 106 submits a bid for the space. In another embodiment, the space for advertisement is sold at a fixed price established by the publisher 102. In other embodiments, the price at which advertising space is sold is determined by an application service provider who has purchased the advertising space from the publisher 102. It should be apparent to one skilled in the art that other pricing models may be used to determine the price an advertising buyer 106 pays for placing an advertisement using the APS 100. It should also be apparent that different pricing models may be used among the publications for which advertising space is sold using the APS 100. Furthermore, the publisher 102 may provide pricing model heuristics that specify how the pricing model for a publication may be changed over time. In one embodiment, a heuristic directs the APS 100 to initially sell advertising space at a fixed price and, if the advertising space remains unsold, may be sold later at auction. In other embodiments, heuristics specify the manner in which the prices for advertisements in a publication are adjusted in response to demand for advertising space. It should be apparent that other heuristics may be used to adjust the price charged while advertising space remains available for sale.

In addition, the publisher 102 may specify advertising availability heuristics that direct the APS 100 to automatically adjust the quantity of advertising real estate available for sale in a publication. In one embodiment, an advertising availability heuristic directs the APS 100 to automatically add advertising pages to a publication if demand is high or delete advertising pages if demand is low. In another embodiment, heuristics direct the APS 100 to add or delete pages over time in response to demand. Still other heuristics direct the APS 100 to move pages within a publication (e.g., from the back of the publication to the front) in response to demand.

Some embodiments of the APS 100 allow a first advertising buyer 106 to review the status of a first submitted bid for advertising space sold using an auction. If a second advertising buyer has submitted a second bid greater than the first bid, then the first advertising buyer 106 may submit a third bid higher than the second. It should be apparent that the APS 100 could implement a number of auction methods to sell the advertising space including a sealed auction, where the advertising buyer 106 is not provided information about previously submitted bids, an English auction where the advertising buyer 106 is apprised of a highest standing bid before submitting a new bid, a Dutch auction where bidding starts at a highest price that is reduced until the advertising space is sold, etc. The operator of the APS 100 or the publisher 102 may select the most appropriate auction method for a particular advertising space in a title.

In one embodiment, the APS 100 incorporates a point of sale subsystem that allows the advertising buyer 106 to pay for the advertisement after selecting the publication in which the advertisement it to appear. In other embodiments, the publisher 102 or the operator of the APS 100, or an agent of either, sends the advertising buyer 106 an invoice for advertising space purchased thereby. In still other embodiments, the APS 100 automatically initiates the generation and sending of an invoice to the advertising buyer 106.

The advertising buyer 106 may upload a file with data representing the advertisement to the APS 100 when purchasing space for the advertisement. Alternately, the advertising buyer 106 may upload the file with data representing the advertisement at a later time or deliver the file on physical media to the publisher 102 or the operator of the APS 100. The data representing the advertisement may be in a file format used for producing print and electronic advertising including QuarkXPress™ developed by Quark, Inc., or InDesign™, PDF, PostScript, Encapsulated PostScript, Flash, developed by Adobe, Inc. The advertising file may also be in an image format such as JPEG or TIFF or a video format such as MPEG. Upon uploading or delivery of the file containing data for an advertisement, the APS 100 verifies the file, stores the file in a repository associated with the APS 100, and adds a reference to the file in the record of the ALB database 104 corresponding to the advertisement.

In some embodiments, the APS 100 incorporates an advertising composition sub-system that allows the advertising buyer 106 to compose the advertisement (e.g., using a web browser). The advertising composition system produces a file with data representing the advertisement and the APS 100 processes the file as if the file had been uploaded by the advertising buyer 106. Some embodiments of the APS 100 incorporate a repository of advertisements previously uploaded or created by the advertising buyer 106. In this case, the advertising buyer 106 selects an advertisement from the repository instead of creating or uploading a new advertisement file.

At a time in accordance with the editorial calendar for a publication, the APS 100 identifies the advertisements that have been purchased by the advertising buyer for inclusion in a publication. The APS then generates final print-ready and/or electronic advertising files and a production database that are sent to a production facility 108. In order to create the final print-ready or electronic advertising files, the APS 100 may, if necessary, convert the files provided by the advertising buyer 106 into a file format necessary for the production facility 108. For example, the production facility 108 may require all files for a print publication to be in PDF format and all files for electronic delivery to be in JPEG format for images or MPEG format for video. The APS 100 may also perform other prepress/pre-flighting operations on each advertising file such as adjusting the size, resolution, or color of the contents thereof. The production database specifies the recipients of the publication and, for each recipient, the customized advertisements (if any) that are to be included in an issue of the publication sent to the recipient.

The production facility 108 receives the print-ready and electronic advertising files and the production database and thereafter generates the final output that is incorporated into a customized advertisement. The customized advertisement includes an advertisement that is targeted to a count or quantity of subscribers. The customized advertisement may be produced in the form of an electronic publication 110 or a print publication 112. The final output incorporated into an electronic publication 110 may involve populating a WWW site or delivering the advertisement to a PDA, an electronic book reader, or other electronic viewer. If the electronic publication 110 is in a video format (e.g., a television program), the production facility 108 produces the advertisement content as video that can be incorporated into a television signal delivered to a subscriber (e.g., as a commercial for a television program delivered via cable). Final output incorporated into a print publication 112 may include printing the advertisements using a conventional (e.g., offset, gravure, etc.) press or a digital press with other content onto a printed sheet and binding or inserting the printed sheet into the print publication 112.

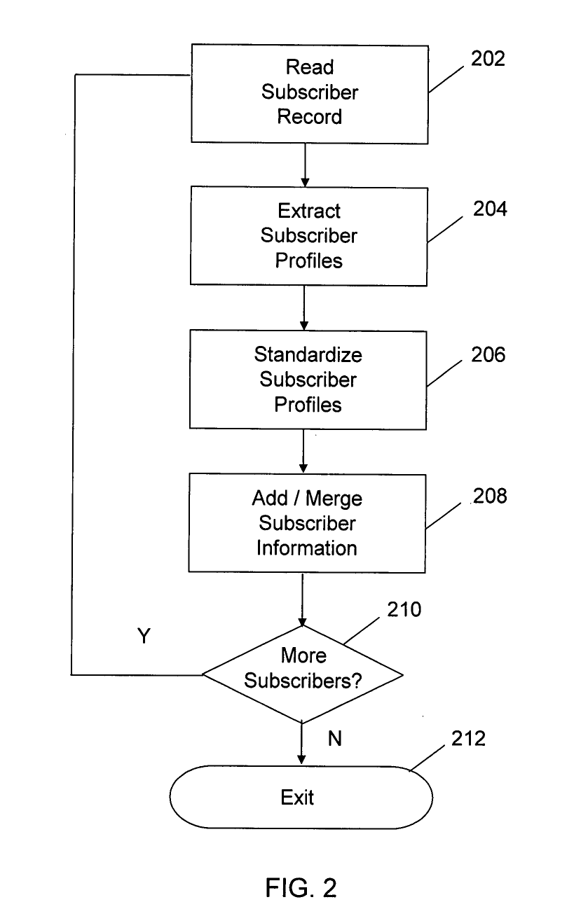

The publisher 102 provides subscriber profiles to the APS 100 in the form of mailing list data. FIG. 2 is a flowchart that depicts how the mailing list data received from a publisher are used to populate the ALB database 104 of FIG. 1. The mailing list data are transmitted electronically by the publisher via the Internet or a private network or delivered on physical media (e.g., a magnetic tape or optical disk). A block 202 reads a subscriber record from the mailing list data and a block 204 extracts subscriber profiles therefrom. Subscriber profiles include name and address information as well as demographic and interest information. The subscriber profiles are standardized at a block 206. Standardization of the subscriber profiles includes cleansing the information and formatting the information into a format consistent with data already stored in the ALB database 104 of FIG. 1. For example, standardization includes cleansing a publication address so that the address follows U.S. Postal Service addressing standards, mapping a specific household income in the subscriber profile to an income range, or mapping interest information (e.g., hiking) to broader categories (e.g., outdoors activities). The standardized subscriber profiles generated at the block 206 are added to the ALB database 104 shown in FIG. 1. If the ALB database 104 does not contain any information for the subscriber then the block 206 creates a new record for the subscriber in the ALB database 104. However, if a record does exist for the subscriber, then the block 208 merges the standardized subscriber profile with the record already in the ALB database 104. A block 210 determines whether the mailing list data contains information regarding additional subscribers and, if so, the processing continues at block 202. Otherwise, the process exits at block 212. The process shown in FIG. 2 may be repeated for additional mailing list data received from a publisher 102.

As noted above, subscriber profiles stored in the APS 100 may be updated. For example, in one embodiment, if the advertising buyer 106 has purchased an advertisement targeted to a subscriber whose information has been deleted, the APS 100 may automatically substitute a different subscriber who matches the profile of the former subscriber. If a different subscriber is not found, then the APS 100 may provide a credit to the advertising buyer 106 accordingly. In another embodiment, the APS 100 may notify the advertising buyer 106 that the subscriber is not available and allow the advertising buyer 106 to select another subscriber.

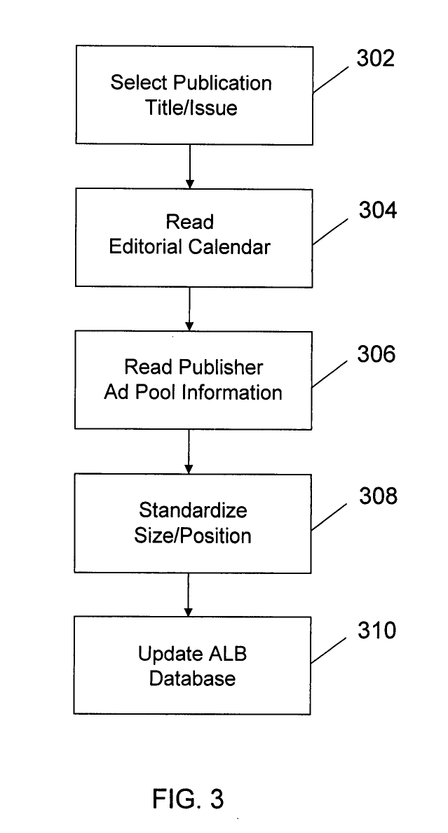

FIG. 3 is a flowchart that illustrates steps undertaken to populate the ALB database 104 of FIG. 1 with advertisement information received from the publisher 102. The advertisement information includes advertising real estate, or more specifically, a listing of advertising available from or for sale by a publisher 102 for a particular issue of a title. At a block 302, the publisher 102 selects the issue and the title of a publication for which advertisement information is to be provided. A block 304 reads an editorial calendar provided by the publisher 102. The editorial calendar for an issue of a title previously entered into the ALB database 104 may be updated or the editorial calendar may include a new calendar for the issue. A block 306 reads advertisement information that includes advertisement space (e.g. ad pool information) that the publisher 102 wishes to sell to advertising buyers using the APS 100. The ad pool information provides, for each advertisement, an acceptable size for the advertisement (e.g., quarter page, half page, full page, double page), the page of the publication on which the advertisement is to appear, location within the page, the cost of the advertisement by size and/or location or if the advertisement is to be auctioned to the best bidder, limitations on content type, etc. The APS 100 normalizes the size and position information of each advertisement to a standard form (e.g., dimensions may be converted to inches, codes may be used to indicate placement in a particular position of the page, etc.) at a block 308. A block 310 updates the records in the ALB database 104 associated with the title and issue selected by the publisher 102. The information collected by blocks 302-306 is collected using a graphical user interface (GUI) provided to a publisher 106 (e.g., via a web browser) or transmitted electronically to the APS 100. For example, the publisher 106 may transmit a database extract or an XML file that conforms to a schema agreed to by the publisher 102 and the operator of the APS 100.

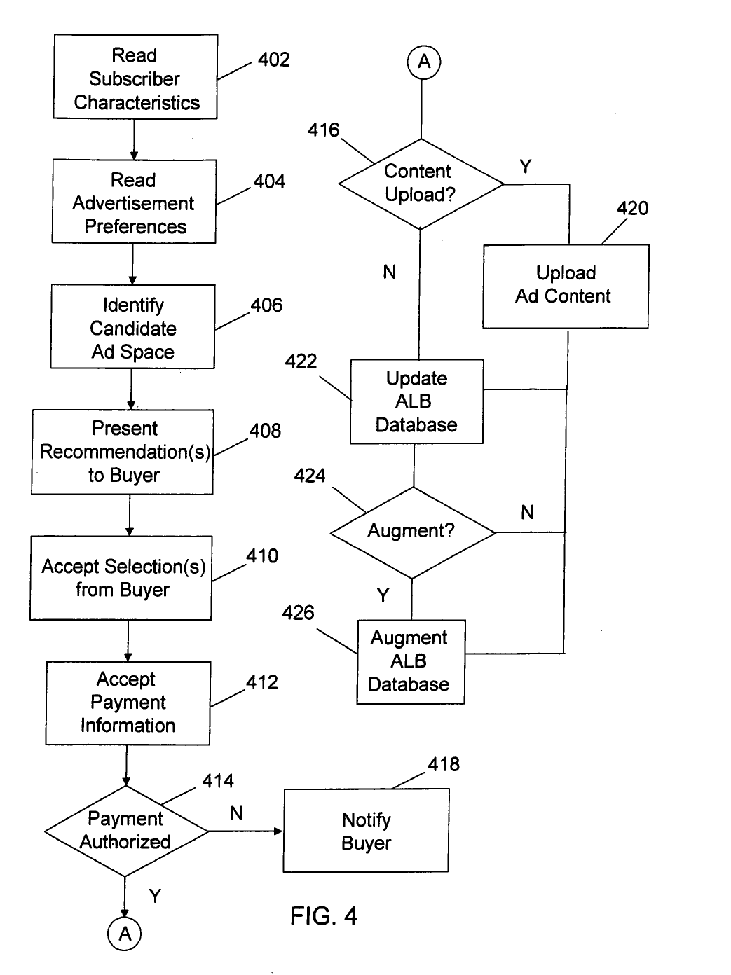

FIG. 4 shows a flow chart of steps undertaken by the APS 100 of FIG. 1 to allow an advertising buyer 106 to select and purchase advertising space(s). A block 402 reads subscriber characteristics from the advertising buyer 106 and a block 404 reads preferences the advertising buyer 106 has for the nature of the advertisement (e.g., page of the publication, size, cost, delivery date, etc). A block 406 uses the information collected at blocks 402 and 404 to formulate and submit a query to the ALB database 104 in order to provide a publication subscriber recommendation(s) that includes candidate issues and/or programs of titles and advertisement space available therein. The identified candidate issues and/or programs are presented to the advertising buyer 106 by a block 408 and include, for each title and/or program identified, the number of subscribers who match the subscriber characteristics. A block 410 allows the advertising buyer 106 to select a title(s) in which to place an advertisement and specify how many of the identified subscribers who match the subscriber characteristics should receive the advertisement. In addition to allowing the advertising buyer 106 to select a title(s) in which to place an advertisement, the block 410 also allows the advertising buyer 106 to select a program(s) of advertisements, either as a series of advertisements over time in a single title with customization to specified subscribers or over a series of titles sent to specified subscribers. The advertising buyer 106 is not limited to one selection, but rather can select multiple titles or programs in which to place advertisements. This aspect of the present invention would allow the advertising buyer 106 to target specific past subscribers, as an example, with highly customized advertisements.

If a particular space for an advertisement selected by the advertising buyer 106 is sold at auction, the block 410 accepts a bid(s) for the advertisement space(s) from the advertising buyer 106 in addition to the selection(s). In some embodiments, the block 410 first displays a previously submitted highest bid and then provides the advertising buyer 106 with an opportunity to submit a higher bid. If the advertising buyer 106, at the block 410, indicated fewer subscribers to receive the advertisement than the number of subscribers who matched the subscriber characteristics, the APS 100 generates the list of subscribers from a subset of the subscribers selected by the advertising buyer subscriber characteristics.

A block 412 accepts payment information from the advertising buyer 106. The payment information includes, for example, a purchase order number, a credit card number, or a preauthorized account number. A block 414 verifies the accuracy of the payment information and, if necessary (e.g., for a credit card), obtains authorization from preconfigured sources (e.g., such as a credit card issuer or an accounts receivable database). If the authorization is denied, a block 418 notifies the advertising buyer 106 that the request for the advertisement space cannot be accepted. Otherwise, a block 416 asks the advertising buyer 106 whether the advertising buyer 106 wishes to upload a file that includes data representing the advertisement(s). If the advertising buyer 106 wishes to upload the file, a block 420 allows the advertising buyer 106 to upload the file and proceeds to a block 422. If, at the block 416, the advertising buyer 106 indicates that the file is not to be uploaded, processing proceeds directly to the block 422. If the advertising buyer 106 does not upload the file, the advertising buyer 106 may provide the file later by uploading the file to the APS 100, sending the file via e-mail or delivering the file on physical media to the operator of the APS 100.

The block 422 updates the ALB database 104 with information provided by the advertising buyer 106 that includes a list of issues, programs, and/or subscribers or demographic characteristics who are to receive the advertisement(s) and the file(s) uploaded by the advertising buyer 106. A block 424 asks the advertising buyer 106 whether the advertising buyer 106 wishes to augment the ALB database 104 with subscriber information provided by third parties. If the advertising buyer 106 wishes to augment the ALB database 104, a block 426 allows the advertising buyer 106 to augment the ALB database 104 by uploading subscriber information supplied by third parties. If, at the block 424, the advertising buyer 106 indicates that the ALB database 104 is not to be augmented, processing proceeds directly to the block 422.

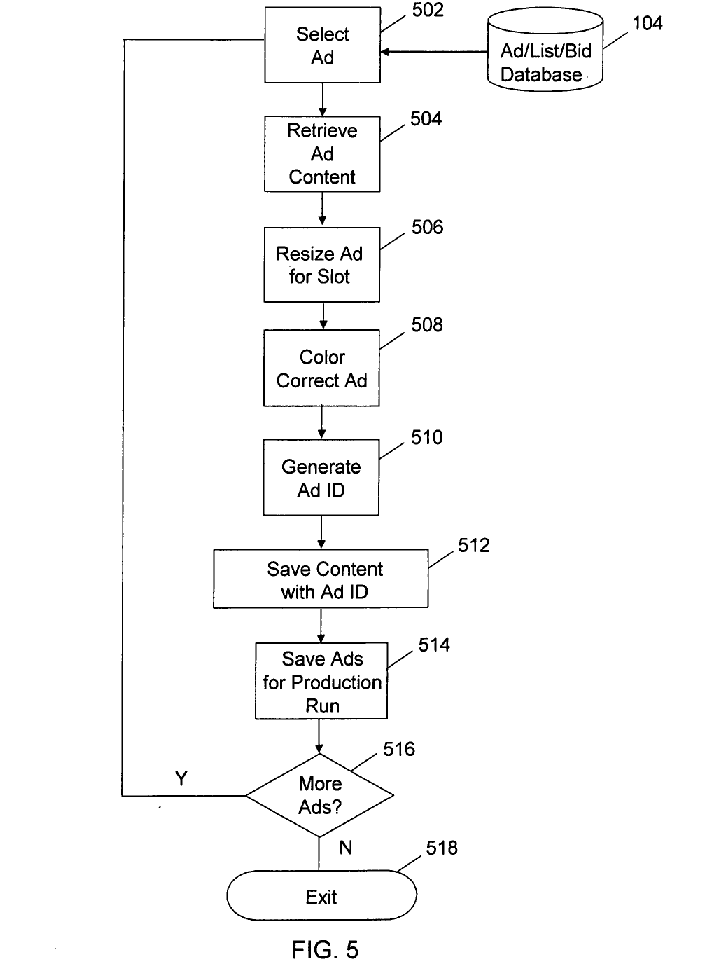

FIG. 5 shows a flowchart depicting the preparation of advertising files for sending to the production facility 108 undertaken by the APS 100 for an issue of a title for which the APS 100 has sold advertising space. A block 502 selects an advertisement sold by the APS 100 from the ALB database 104 of FIG. 1. A block 504 retrieves a file that contains content for the advertisement and makes a working copy thereof. A block 506 resizes the content in the working copy file as necessary to fit a slot for the advertisement and a block 508 applies color correction to the content to match characteristics of the output media. A block 510 generates an advertisement ID for the working copy file and a block 512 associates the working copy therewith. In some embodiments of the APS 100, the name of the working copy file is changed to include the advertisement ID. In these embodiments, the block 512 adds the advertisement ID and the name of the working copy file to a record of the ALB database 104 associated with the advertisement selected at the block 502. A block 514 saves the working copy file into a production run folder for the issue of the title. A block 516 determines if there are additional advertisement files that need to be processed. If further processing is required, processing proceeds to block 502. Otherwise, the process exits at a block 518.

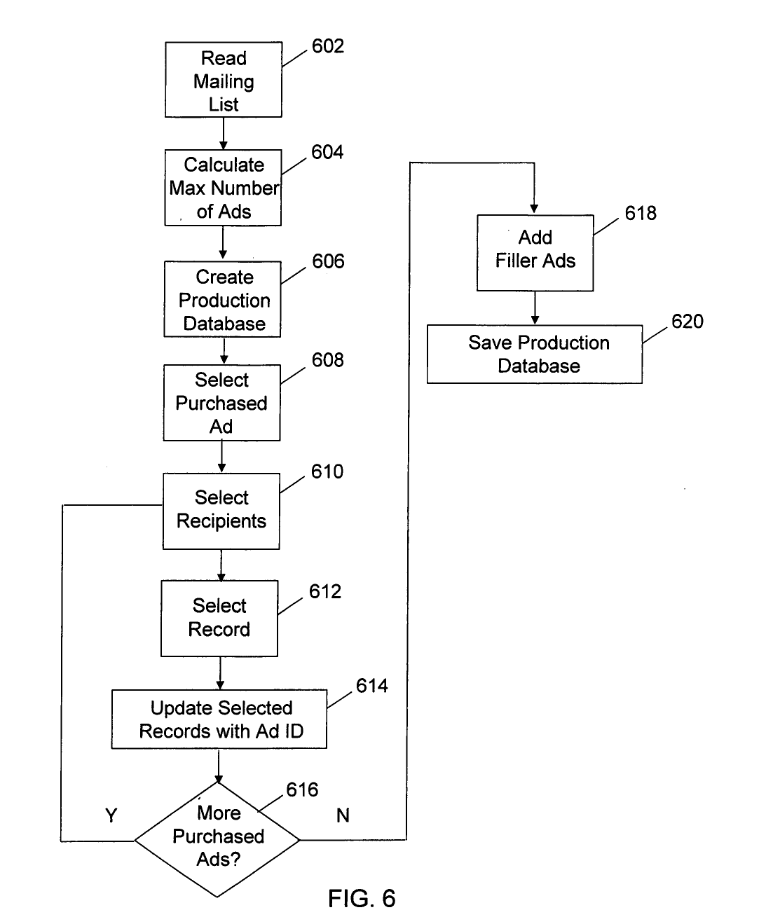

FIG. 6 shows a flowchart for preparing a production database that may be used by the production facility 108 of FIG. 1 to produce customized advertisement pages that are included in an issue of a publication. A block 602 reads a mailing list of a title. A block 604 extracts information from the ALB database 104 regarding advertisements purchased by the advertising buyer 106 using the APS 100 and compares the number of advertisements each subscriber is to receive in order to identify the subscriber who is to receive a maximum number (N_{MAX}) of advertisements. A block 606 creates a production database having fields to hold the mailing list information and N_{MAX} number of customized advertisement fields to hold a reference to a customized advertisement. The block 606 initializes each customized advertisement field of each record of the production database to be empty (i.e., with a NULL character, an empty string, etc.). The block 606 thereafter creates a record in the production database for each recipient in the mailing list and populates the record with mailing list data for the recipient. A block 608 selects a purchased advertisement from the ALB database 104. A block 610 identifies the recipients who are to receive the purchased advertisement and for each recipient selected at the block 610, a block 612 selects the record of the production database corresponding thereto. A block 614 copies the advertisement ID associated with the purchased advertisement into one of the customized advertisement fields of the record that is empty. A block 616 checks if there is an additional purchased advertisement and, if there is, processing proceeds to block 610, otherwise processing proceeds to a block 618.

The block 618 reads each record of the production database and iterates through each customized advertisement field thereof that is not empty and calculates the total number of physical pages needed to hold the customized advertisement. If the total number of physical pages is not an integer, the block 618 adds references to filler advertisements to empty customized advertisement fields of the record so that the number of physical pages is an integer. In one embodiment of the present invention, the block 618 calculates the number of signatures required to hold customized advertisements and, if the number of signatures is not an integer, the block 618 adds sufficient references to the filler advertisements. In other embodiments, additional advertisement fields are not added and extra advertisement space is left blank in the final output pages. A block 620 saves the production database so that it may be used by the production facility 108 of FIG. 1.

The production facility 108 of FIG. 1 uses the production database and variable data processing software known to those skilled in the art to generate a set of customized pages for each record of the production database. One example of such software that may be used to produce customized pages is disclosed in Warmus et al., U.S. Pat. Nos. 6,327,599 and 6,332,149, which are incorporated herein by reference. In addition, the advertising preferences provided by the advertisement buyer 106 for advertisement content may include variable data position information regarding placement of variable data in such content. In one embodiment, the production facility 108 may use the variable data software to further incorporate variable data in accordance with the variable data position information. In another embodiment, the customized pages of advertisements produced by the production facility 108 may be bound into a publication with other pages that are not customized in a bindery, as described in Harris, Jr. et al., U.S. Pat. No. 5,114,128.

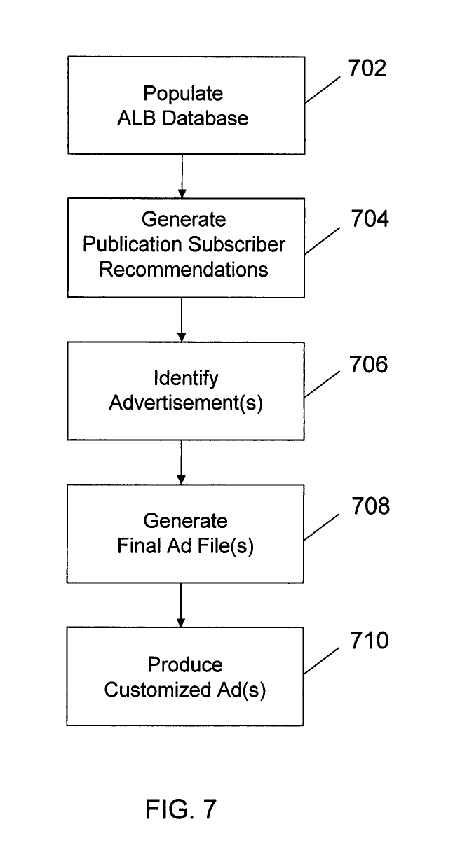

FIG. 7 is a flowchart that illustrates the steps for preparing a customized advertisement undertaken by the APS 100 of FIG. 1. A block 702, populates ALB database 104 with advertisement information and subscriber profiles received from a publisher and subscriber characteristics received from an advertising buyer. The subscriber profiles can be cross-referenced between multiple participating publishers to ensure accuracy. The ALB database 104 may also include advertising preferences received from the advertising buyer. Additionally, the ALB database 104 can be augmented with subscriber information provided by third parties. A block 704 generates publication subscriber recommendations for the advertising buyer from the information contained within the ALB database 104. A block 706 identifies an advertisement(s) purchased by the advertising buyer and the number of subscribers who match the subscriber characteristics that should receive the advertisement(s) based on the publication subscriber recommendations. A block 708 generates a final advertising file(s) and a production database. Block 710 produces a customized advertisement(s) from the advertising file(s) and the production database. In one embodiment, the customized advertisement is a printed publication. In another embodiment, the customized advertisement is an electronic publication.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications that come within the scope of the appended claims are reserved.

### INDUSTRIAL APPLICABILITY

An advantageous application for the invention lies in the targeting of advertisements to individual subscribers.

We claim:

1. A method for selecting publication subscribers for targeted advertisements, comprising the steps of:
receiving advertisement information and subscriber profiles from a publisher;
receiving subscriber characteristics from an advertising buyer;
analyzing the available advertisement information, the subscriber profiles, and the subscriber characteristics;
generating a publication subscriber recommendation for the advertising buyer based on the analyzing step; and
receiving a purchasing bid from the advertising buyer based on the publication subscriber recommendation.

2. The method of claim 1, wherein the advertisement information comprises advertisement real estate.

3. The method of claim 1, wherein the advertisement information comprises an editorial calendar.

4. The method of claim 1, wherein the subscriber profiles comprise mailing list data.

5. The method of claim 1, wherein the subscriber profiles comprise identification information for a subscriber and titles that the subscriber receives.

6. The method of claim 1, wherein the subscriber profiles comprise demographic or interest information about a subscriber.

7. The method of claim 1, wherein the method comprises the further step of cross-referencing the subscriber profiles between multiple participating publishers.

8. The method of claim 1, wherein the subscriber profiles comprise a subscriber code.

9. The method of claim 1, wherein the advertisement information and subscriber profiles are normalized to a standard form.

10. The method of claim 1, wherein the subscriber characteristics comprise a period of time when an advertisement needs to reach a consumer.

11. The method of claim 1, wherein the publication subscriber recommendation comprises information regarding a collection of publication subscribers, candidate issues of titles with advertising space available, or circulation information.

12. The method of claim 1, wherein the method comprises the further step of receiving advertising preferences from the advertising buyer.

13. The method of claim 1, wherein the method comprises the further step of receiving a list of subscribers or demographic characteristics who are to receive an advertisement from the advertising buyer.

14. The method of claim 13, wherein the list of subscribers receive the advertisement either as a series of advertisements over time in a single title or over a series of titles.

15. The method of claim 1, wherein the method comprises the further step of utilizing pricing model heuristics.

16. The method of claim 1, wherein the method comprises the further step of utilizing advertising availability heuristics.

17. The method of claim 1, wherein the method comprises the further step of identifying a subscriber who is to receive a maximum number of advertisements.

18. The method of claim 1, wherein the generating step comprises the further step of displaying a count of subscribers that comprise the publication subscriber recommendation.

19. The method of claim 18, comprising the step of receiving from the advertising buyer a number of subscribers who should receive an advertisement.

20. A method for targeting advertising to selected publication subscribers, comprising the steps of:
populating a database with advertisement information and subscriber profiles received from a publisher and subscriber characteristics received from an advertising buyer;
generating a publication subscriber recommendation for the advertising buyer from the database;
identifying an advertisement purchased by the advertising buyer based on the publication subscriber recommendation;
generating a final advertising file and a production database; and
producing a customized advertisement from the final advertising file and the production database.

21. The method of claim 20, wherein the customized advertisement is in a print publication.

22. The method of claim 20, wherein the customized advertisement is in an electronic publication.

23. A method for selecting publication subscribers for targeted advertisements, comprising the steps of:
populating a database with advertisement information and subscriber profiles received from a publisher and subscriber characteristics received from an advertising buyer;
augmenting the database with information provided by third party providers;
generating a publication subscriber recommendation for the advertising buyer from the database; and
receiving a purchasing bid from the advertising buyer based on the publication subscriber recommendation.

24. The method of claim 23, wherein the method comprises the further step of cross-referencing the subscriber profiles between multiple participating publishers.

25. The method of claim 23, wherein the publication subscriber recommendation comprises information regarding a collection of publication subscribers, candidate issues of titles with advertising space available, or circulation information.

26. The method of claim 23, wherein the method comprises the further step of receiving advertising preferences from the advertising buyer.

27. The method of claim 23, wherein the generating step comprises the further step of displaying a count of subscribers that comprise the publication subscriber recommendation.

28. A system for selecting a publication subscriber for a targeted advertisement, comprising:
a database comprising advertisement information and subscriber profiles received from a publisher;
an interface that receives subscriber characteristics from an advertising buyer;
an analysis component to analyze the advertisement information, the subscriber profiles, and the subscriber characteristics, whereby the analysis component provides a publication subscriber recommendation to the advertising buyer; and
an interface that receives a purchasing bid from the advertising buyer based on the publication subscriber recommendation.

29. The system of claim 28, wherein the advertisement information comprises advertisement real estate.

30. The system of claim 28, wherein the advertisement information comprises an editorial calendar.

31. The system of claim 28, wherein the subscriber profiles comprise mailing list data.

32. The system of claim 28, wherein the subscriber profiles comprise identification information for a subscriber and titles that the subscriber receives.

33. The system of claim 28, wherein the subscriber profiles comprise demographic or interest information about a subscriber.

34. The system of claim 28, wherein the subscriber profiles comprise a subscriber code.

35. The system of claim 28, wherein the advertisement information and subscriber profiles are normalized to a standard form.

36. The system of claim 28, wherein the subscriber characteristics comprise a period of time when an advertisement needs to reach a consumer.

37. The system of claim 28, wherein the publication subscriber recommendation comprises information regarding a collection of publication subscribers, candidate issues of titles with advertising space available, or circulation information.

38. The system of claim 28, wherein the database further comprises advertising preferences from the advertising buyer.

39. The system of claim 28, wherein the system further comprises pricing model heuristics.

40. The system of claim 28, wherein the system further comprises advertising availability heuristics.

41. The system of claim 28, wherein the interface receives payment information from the advertising buyer.

42. The system of claim 28, wherein the system further comprises an authorization component that verifies the accuracy of information and obtains authorization from preconfigured sources.

43. The system of claim 28, wherein the system further comprises a point of sale subsystem.

44. The system of claim 28, wherein the system further comprises an advertising composition subsystem.

45. The system of claim 28, wherein the system further comprises a production facility whereby customized advertisement pages are generated.
